(19) United States
(12) Patent Application Publication
(10) Pub. No.: US 2024/0333175 A1
(43) Pub. Date: Oct. 3, 2024

(54) VOLTAGE CONVERTER

(71) Applicant: STMicroelectronics International N.V., Geneva (CH)

(72) Inventors: Yannick HAGUE, Mettray (FR); Guillaume THIENNOT, Pernay (FR); Romain LAUNOIS, Tours (FR)

(73) Assignee: STMicroelectronics International N.V., Geneva (CH)

(21) Appl. No.: 18/614,887

(22) Filed: Mar. 25, 2024

(30) Foreign Application Priority Data
Mar. 29, 2023 (FR) 2303012

(51) Int. Cl. H02M 7/53846; H02M 7/5383

(52) U.S. Cl. CPC H02M 7/538463; H02M 7/538466; H02M 7/53835

(57) ABSTRACT

A converter circuit is configured to convert a DC voltage into an AC voltage using a first thyristor and second thyristor in series in a first branch, a third thyristor and fourth thyristor in series in a second branch in an antiparallel configuration to the first branch, and a first transistor and second transistor in series in a third branch. When the AC voltage is equal to zero, and when the first thyristor is conductive and the first and second transistors are non-conductive, a first positive current is applied to the gate of the antiparallel third thyristor to control turn on and ensure that the current circulating in the first thyristor falls below the holding current.

### PRIORITY CLAIM

This application claims the priority benefit of French Application for U.S. Pat. No. 2,303,012, filed on Mar. 29, 2023, the content of which is hereby incorporated by reference in its entirety to the maximum extent allowable by law.

### TECHNICAL FIELD

The present disclosure generally relates to the issue of voltage converting and, in particular, to the issue of converting a DC voltage into an AC voltage. The present disclosure more particularly relates to a device or circuit converting a DC voltage into an AC voltage, and the control method thereof.

### BACKGROUND

Voltage converting, and particularly converting a DC voltage into an AC voltage, is a technical field continuously evolving and constantly expanding.

It would be desirable to be able to improve at least in part some aspects of the known voltage converting circuits, and particularly the methods for controlling such converting circuits.

There is a need for more efficient voltage converting devices or circuits.

There is a need for more efficient DC voltage to AC voltage converting devices or circuits.

There is a need for methods for controlling voltage converting devices or circuits allowing such devices or circuits to be made more efficient.

There is a need to address all or some of the drawbacks of the known methods for controlling a voltage converting device or circuit.

### SUMMARY

One embodiment provides a method for controlling a converter of a DC voltage into an AC voltage comprising: a first thyristor the anode of which is coupled with a first input node and the cathode of which is coupled with a second output node; a second thyristor the anode of which is coupled with the second output node and the cathode of which is coupled with a third input node; a third thyristor the anode of which is coupled with the second output node and the cathode of which is coupled with the first input node; a fourth thyristor the anode of which is coupled with the third input node and the cathode of which is coupled with the second output node; a first transistor a first conduction terminal of which is coupled with the first input node and a second conduction terminal of which is coupled with a fourth output node; a second transistor a first conduction terminal of which is coupled with the fourth output node and a second conduction terminal of which is coupled with the third input node; wherein when said AC voltage is equal to zero, and when said first thyristor is conductive and said first and second transistors are non-conductive, then a first positive current is applied to the gate of said third thyristor.

Another embodiment provides a converter of a DC voltage into an AC voltage comprising: a first thyristor the anode of which is coupled with a first input node and the cathode of which is coupled with a second output node; a second thyristor the anode of which is coupled with the second output node and the cathode of which is coupled with a third input node; a third thyristor the anode of which is coupled with the second output node and the cathode of which is coupled with the first input node; a fourth thyristor the anode of which is coupled with the third input node and the cathode of which is coupled with the second output node; a first transistor a first conduction terminal of which is coupled with the first input node and a second conduction terminal of which is coupled with a fourth output node; a second transistor a first conduction terminal of which is coupled with the fourth output node and a second conduction terminal of which is coupled with the third input node; wherein when said AC voltage is equal to zero, and when said first thyristor is conductive and said first and second transistors are non-conductive, then a first positive current is sent to the gate of said third thyristor.

According to an embodiment, said first current is delivered by a power supply circuit.

According to an embodiment, when said second thyristor is conductive and said first and second transistors are non-conductive, then a second positive current is applied to the gate of said fourth thyristor.

According to an embodiment, said second current is delivered by a power supply circuit.

According to an embodiment, said first and second transistors are NMOS-type transistors.

According to an embodiment, said first, second, third, and fourth thyristors are configured to receive a maximum voltage in the order of 1,200 V across their conduction terminals.

According to an embodiment, said converter further comprises a capacitor coupling the first input node with said third input node.

According to an embodiment, said converter further comprises a coil coupling said fourth output node with a fifth middle node between said first and second transistors.

According to an embodiment, said DC voltage is adapted to be applied between the first input node and said third input node, and said AC voltage is adapted to be supplied between said second output node and said fourth output node.

Another embodiment provides a charger comprising a circuit described previously.

Another embodiment provides a solar panel comprising a circuit described previously.

Another embodiment provides an automotive vehicle comprising a circuit described previously.

### BRIEF DESCRIPTION OF THE DRAWINGS

The foregoing features and advantages, as well as others, will be described in detail in the following description of specific embodiments given by way of illustration and not limitation with reference to the accompanying drawings, in which:

FIG. 1 illustrates an embodiment of a voltage converting circuit;

FIG. 2 illustrates a graph representing the operation of the circuit of FIG. 1;

FIG. 3 illustrates two graphs representing the operation of the circuit of FIG. 1;

FIG. 4 illustrates an electrical scheme representing an implementation of a method for controlling the circuit of FIG. 1;

FIG. 5 illustrates an example embodiment of a power supply circuit of the circuit of FIG. 1;

FIG. 6 illustrates a graph representing the operation of the circuit of FIG. 5; and

FIG. 7 illustrates a curve representing a detail of the control method of FIG. 4.

### DETAILED DESCRIPTION

Like features have been designated by like references in the various figures. In particular, the structural and/or functional features that are common among the various embodiments may have the same references and may dispose identical structural, dimensional and material properties.

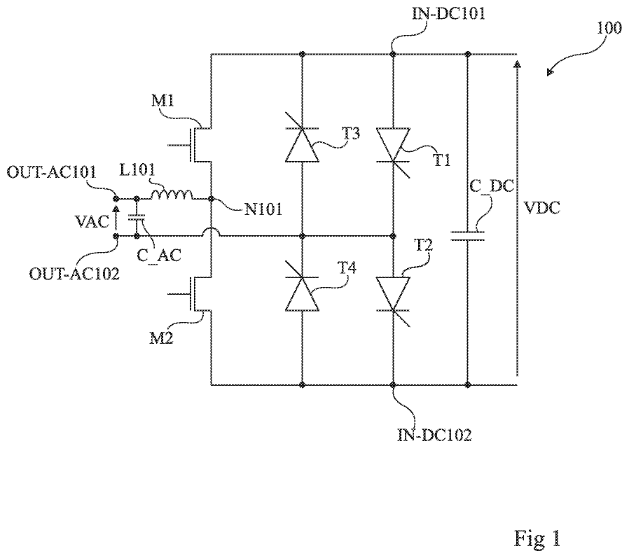

For the sake of clarity, only the operations and elements that are useful for an understanding of the embodiments described herein have been illustrated and described in detail. In particular, the usual detailed operation of a voltage converting circuit of the type of the one described in relation with FIG. 1 is not described here, and is considered as being within the capabilities of those skilled in the art.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, unless indicated otherwise, when reference is made to absolute positional qualifiers, such as the terms “front”, “back”, “top”, “bottom”, “left”, “right”, etc., or to relative positional qualifiers, such as the terms “above”, “below”, “higher”, “lower”, etc., or to qualifiers of orientation, such as “horizontal”, “vertical”, etc., reference is made to the orientation shown in the figures.

Unless specified otherwise, the expressions “around”, “approximately”, “substantially” and “in the order of” signify within 10%, and preferably within 5%.

FIG. 1 illustrates an embodiment of a voltage converting circuit 100.

The circuit 100 allows a DC voltage VDC to be converted into an AC voltage VAC. According to an embodiment, the circuit 100 is a bidirectional converting circuit, and further allows the AC voltage VAC to be converted into the DC voltage VDC. The embodiments hereafter described only relate to the operation of the circuit 100 for converting the DC voltage VDC into the AC voltage VAC. According to a preferred example, the circuit 100 is configured to receive a minimum DC voltage VDC of 380 V, and to deliver an AC voltage of minimum effective voltage of 85 V and having a minimum frequency of the order of 40 Hz.

According to an embodiment, the circuit 100 is a bidirectional converting circuit using a totem-pole-type assembly, i.e., a cascode (push-pull) assembly in which the active components are identical transistors, receiving the same opposite-phase signals.

According to an embodiment, the circuit 100 comprises two electronic nodes IN-DC101 and IN-DC102 the potential difference of which is equal to the DC voltage VDC. As the case described here relates to converting the DC voltage VDC into the AC voltage VAC, the nodes IN-DC101 and IN-DC102 are hereafter called input nodes of the circuit 100.

Similarly, according to an embodiment, the circuit 100 comprises two electronic nodes OUT-AC101 and OUT-AC102 the potential difference of which is equal to the AC voltage VAC. The nodes OUT-AC101 and OUT-AC102 are hereafter called input nodes of the circuit 100.

The circuit 100 comprises a capacitor C-DC coupling the input nodes IN-DC101 and IN-DC102.

The circuit 100 further comprises a first branch, between its input nodes IN-DC101 and IN-DC102, including a thyristor T1 and a thyristor T2. An anode of the thyristor T1 is coupled with, preferably connected to, the input node IN-DC101, and a cathode of the thyristor T1 is coupled with, preferably connected to, the output node OUT-AC102. An anode of the thyristor T2 is coupled with, preferably connected to, the output node OUT-AC102, and a cathode of the thyristor T2 is coupled with, preferably connected to, the input node IN-DC102. The gates of the thyristors T1 and T2 are configured to receive control currents.

The circuit 100 further comprises a second branch, between its input nodes IN-DC101 and IN-DC102, including a thyristor T3 and a thyristor T4. A cathode of the thyristor T3 is coupled with, preferably connected to, the input node IN-DC101, and an anode of the thyristor T3 is coupled with, preferably connected to, the output node OUT-AC102. A cathode of the thyristor T4 is coupled with, preferably connected to, the output node OUT-AC102, and an anode of the thyristor T4 is coupled with, preferably connected to, the input node IN-DC102. The gates of the thyristors T3 and T4 are configured to receive control currents.

The circuit 100 comprises a third branch, between its input nodes IN-DC101 and IN-DC102 including two transistors M1 and M2 constituting a totem-pole-type assembly. According to an embodiment, the transistors M1 and M2 are insulated-gate field-effect transistors, or metal-oxide-semiconductor structure field-effect transistors, more usually called MOSFET transistors (Metal-Oxide-Semiconductor Field-Effect Transistor), or MOS transistors. More particularly, the transistors M1 and M2 are N-channel MOS-type transistors, also called NMOS transistors. A first conduction terminal of the transistor M1 is coupled with, preferably connected to, the input node IN-DC101, and a second conduction terminal of the transistor M1 is coupled with, preferably connected to, a node N101. A first conduction terminal of the transistor M2 is coupled with, preferably connected to, the node N101, and a second conduction terminal of the transistor M2 is coupled with, preferably connected to, the input node IN-DC101. The node N101 is also called middle node between the transistors M1 and M2. The control terminals of the transistors M1 and M2 are configured to receive control voltages.

The circuit 100 further comprises a coil (inductor) L101 coupling the node N101 to the output node OUT-AC101.

The circuit 100 further and finally comprises an optional filtering capacitor C_AC coupling the output nodes OUT-AC101 and OUT-AC102.

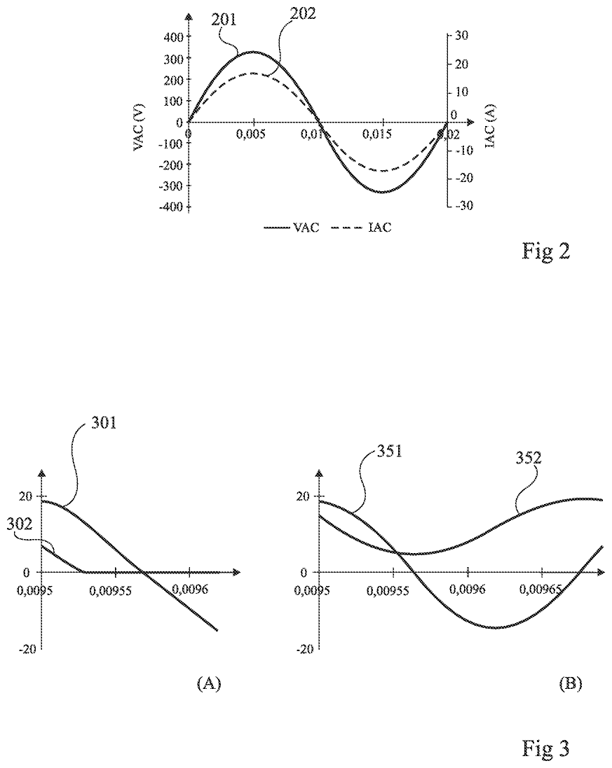

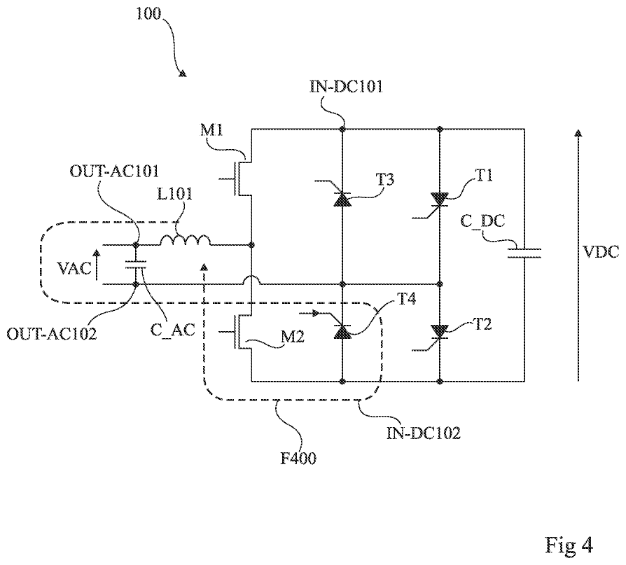

The operation of the circuit 100 is described in relation with FIGS. 2-4. Particularly, an implementation of a control method of the circuit 100 is described in relation with FIG. 4.

FIG. 2 illustrates two curves 201 and 202 representing the operation of the circuit 100 described in relation with FIG. 1.

More particularly, the curves 201 and 202 are two time diagrams representing the evolution of the AC voltage VAC and of an AC current IAC, respectively, both delivered at the output of the circuit 100. More particularly, as previously mentioned, the AC voltage VAC is delivered between the nodes OUT-AC101 and OUT-AC102. The current IAC is delivered at the node OUT-AC101.

When the voltage VAC and the current IAC are positive, the thyristor T1 is controlled to be non-conductive, and the thyristor T2 is controlled to be conductive. The transistor M1 is controlled to be periodically conductive, and the transistor M2 is controlled to be non-conductive. The thyristors T3 and T4 are non-conductive.

When the voltage VAC and the current IAC are negative, the thyristor T1 is controlled to be conductive, and the thyristor T2 is controlled to be non-conductive. The transistor M1 is controlled to be non-conductive, and the transistor M2 is controlled to be periodically conductive. The thyristors T3 and T4 are non-conductive.

FIG. 3 comprises two graphs (A) and (B) representing in more detail the operation of the circuit 100 described in relation with FIG. 1.

The graph (A) comprises a curve 301 and a curve 302. The curves 301 and 302 are two time diagrams illustrating the evolution of an AC voltage VC_AC and of a current IL, respectively. More particularly, the AC voltage VC_AC is the voltage across the terminals of the capacitor C_AC. The current IL is the current delivered at the output of the coil L101.

Similarly, the graph (B) comprises a curve 351 and a curve 352. The curves 351 and 352 are two time diagrams illustrating the evolution of the previously defined AC voltage VC_AC and current IL, respectively.

The graphs (A) and (B) illustrate the operation of the circuit 100 of FIG. 1 just before the time when the AC voltage VAC and the AC current IAC change their sign (i.e., just before zero cross). In the example represented in FIG. 3, the graphs (A) and (B) illustrate the operation of the circuit 100 at the time when the AC voltage VAC and the AC current IAC are positive and prepare to become negative. At this time, the thyristor T2, that was conductive, turns non-conductive, and the thyristor T1, that was non-conductive, turns conductive after the zero-crossing of the AC voltage VAC. The transistors M1 and M2 are at this time non-conductive. Thus, the current IL flowing through the coil is equal to the current flowing through the thyristor T2.

The graph (A) illustrates a case of standard operation, during which the current IL present in the coil L101 also goes to zero before voltage VC_AC of capacitor C_AC gets inverted. The current in the thyristor T2 is equal to current IL, but is inferior to the holding current of thyristor T2. Thus, thyristor T2 becomes non-conducting.

The graph (B) illustrates a case of abnormal operation, during which when voltage VC_AC of capacitor C_AC goes to zero, the current IL present in the coil and circulating in the thyristor T2 is greater than the holding current of thyristor T2. Thyristor T2 is still conducting when voltage VC_AC gets inverted. This inversion of voltage VC_AC leads to an increase of the current in thyristor T2 and prevents its opening. This resonance phenomenon is a parasitic phenomenon that delays the stop of the thyristor T2. A control method of the circuit 100 described in relation with FIG. 4 allows this abnormal operation case to be avoided.

Similarly, this parasitic resonance phenomenon may also occur when the AC voltage VAC and the AC current IAC are negative and turn positive. In this case, it is the thyristor T1 that was conductive and turns non-conductive.

It will be noted that in the case of the noted resonance phenomena, the presence of freewheel current flow through the intrinsic diode for transistors M1 and M2 is insufficient to cancel the current circulating in the thyristors T1, T2 (for example under certain voltage and current conditions). Additional circuit control is needed to ensure that the current circulating in the thyristor T2 falls below the holding current of thyristor T2 to allow the opening of thyristor T2 at the proper time.

FIG. 4 illustrates the circuit 100 described in relation with FIG. 1 and allows an implementation of a method for controlling the circuit 100 to be illustrated.

According to an embodiment, to avoid the occurring of the parasitic resonance phenomenon described in relation with FIG. 3, at the time when the AC voltage VAC and the AC current IAC modify their sign, the thyristor T3 or T4 being antiparallel with the thyristor T1 or T2 that stops conducting, goes conductive to absorb the residual current flowing through the coil L101. This absorbed current is in addition any freewheel current in the intrinsic diode of the MOS transistor. To this end, a positive current is applied to the gate of said thyristor T3 or T4 to control turn on. The effect is empty the thyristor T1 or T2 of current to a level below the holding current level and cause the thyristor to open.

More particularly, in the case illustrated in FIG. 4, the AC voltage VAC and the AC current IAC were positive and go negative. The thyristor T2 stops conducting, and the thyristor T4 goes conductive by applying a positive control current on its gate. The path of the charges of the residual current of the coil L101 is illustrated in FIG. 4 with a dotted arrow F400. Indeed, in this configuration, the thyristor T4 is reverse biased and its performance approaches that of a low gain bipolar transistor.

In the opposite case, i.e., when the AC voltage VAC and the AC current IAC were negative and go positive, the thyristor T1 stops conducting, and the thyristor T3 goes conductive by applying a control current on its gate.

Thus, for example, the solution presented is to make the thyristor T4 conductive, at the moment when the alternating voltage changes sign, to redirect the current from the coil to the thyristor T4 and deflect that current from the thyristor T2 (in addition to deflection of current which occurs by means of current flow through the intrinsic diode of transistor M2). This has the effect of “emptying” the thyristor T2 of its current and thus causing the thyristor to open (turn off).

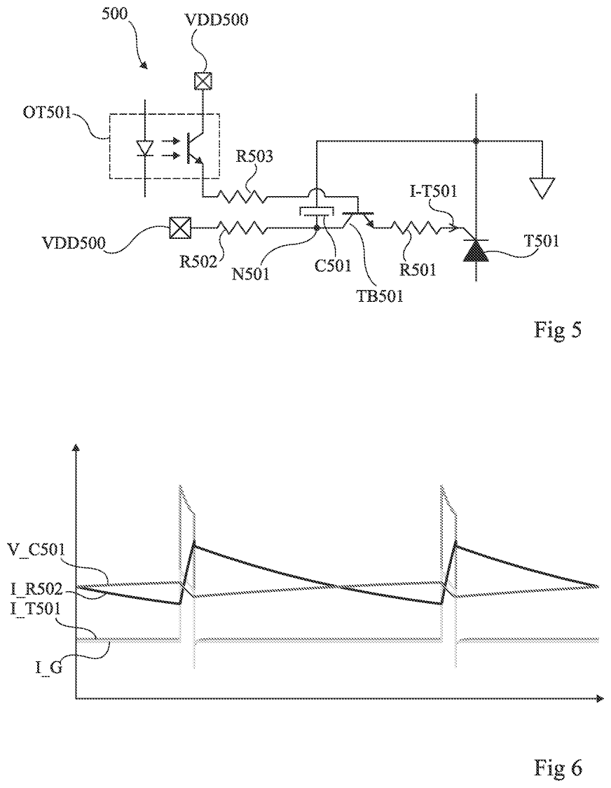

An example embodiment of a circuit for controlling the thyristors T3 and T4 allowing said control current to be applied to the gate of the thyristors T3 and T4 and the operation thereof is described in relation with FIGS. 5 and 6.

FIG. 5 illustrates an example embodiment of a control circuit 500 of a thyristor T501 used to deliver a control current I_T501 at the gate of the thyristor T501. According to an example, the thyristor T501 is the thyristor T3 or T4 of the circuit 100 described in relation with FIG. 1.

The control circuit 500 comprises two resistors R501 and R502, and an NPN-type bipolar transistor TB501. A first terminal of the resistance R501 is coupled with, preferably connected to, an output node of the circuit 500, i.e., practically the gate of the thyristor T501. A second terminal of the resistance R501 is coupled with, preferably connected to, the emitter of the transistor TB501. The collector of the transistor TB501 is coupled with, preferably connected to, a first terminal of the resistor R502, also called node N501. A second terminal of the resistor R502 is coupled with, preferably connected to, a node receiving a power supply voltage VDD500, for example in the order of 5 V.

The control circuit 500 further comprises a capacitor C501 coupling the node N501 to the cathode of the thyristor T501. According to an example, the capacitor C501 is a biased capacitor. According to an example, the cathode of the thyristor is a reference node, for example receiving a reference potential such as ground.

The control circuit 500 further comprises a resistor R503 and an optocoupler OT501. A first terminal of the resistor is coupled with, preferably connected to, the base of the transistor TB501. A second terminal of the resistor R503 is coupled with, preferably connected to, a first conduction terminal of the optocoupler OT501. A second conduction terminal of the optocoupler OT501 is coupled with, preferably connected to, a node receiving the power supply voltage VDD500.

FIG. 6 illustrates a graph representing the operation of the control circuit 500 during the implementation of the control method described in relation with FIG. 4.

More particularly, the graph of FIG. 6 comprises: a curve IG illustrating the evolution over time of the control current delivered to the gate of thyristor T501; a curve I_T501 illustrating the evolution over time of the current reaching the cathode of thyristor T501; a curve I_R502 illustrating the evolution over time of the charge current of resistor R502; and a curve V_C501 illustrating the evolution over time of the voltage across capacitor C501.

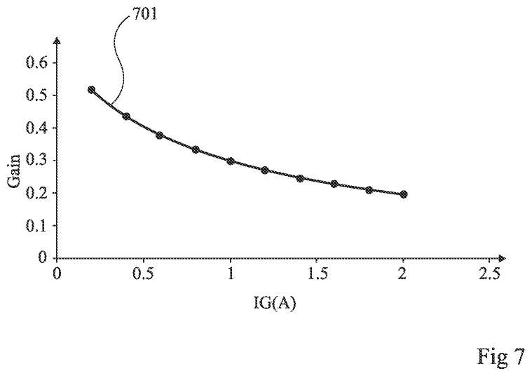

The control circuit 500 is sized to deliver a positive control current in the order of the 4.5 A at the gate of the thyristor each time the AC voltage VAC and the AC current IAC go to zero, as previously described. An example of determining the control current value is described in relation with FIG. 7.

To this end, the capacitor C501 is charged by the power supply voltage VDD500 and the resistor R502. Periodically, the optocoupler OT501 drives the bipolar transistor TB501 ON. The capacitor C501 then discharges and delivers the control current to the gate of the thyristor T501.

FIG. 7 illustrates a graph 701 representing the evolution of the gain of a reverse biased thyristor as a function of the current applied to its gate.

The graph 701 indicates that the greater the gate current, the lower the thyristor gain. Thus, to implement the control method described in relation with FIG. 5, it is necessary to use a control current enough high, but during a time period relatively short, which allows not consuming too much energy.

Particular examples of application of the circuit 100 and of the control method described in relation with FIG. 4 are bidirectional power converters used in the automotive industry, e.g., in particular the hybrid and electrical automotive vehicle industry, the field of high power chargers, e.g., the automotive chargers for private homes, and/or for public spaces, and the field of the renewable energy, e.g., solar panels, the field of uninterruptible power supply, etc. Power converters concerned by these fields are adapted to convert an AC voltage into a DC voltage, and/or a DC voltage into an AC voltage.

Various embodiments and variants have been described. Those skilled in the art will understand that certain features of these embodiments can be combined and other variants will readily occur to those skilled in the art.

Finally, the practical implementation of the embodiments and variants described herein is within the capabilities of those skilled in the art based on the functional description provided hereinabove.

1. A method for controlling a converter of a DC voltage into an AC voltage, wherein the converter comprises:
a first thyristor having an anode coupled to a first input node and a cathode coupled to a first output node;
a second thyristor having an anode coupled to the first output node and a cathode coupled to a second input node;
a third thyristor having an anode coupled with the first output node and a cathode coupled to the first input node;
a fourth thyristor having an anode coupled to the second input node and a cathode coupled to the first output node;
a first transistor having a first conduction terminal coupled to the first input node and a second conduction terminal coupled to a second output node; and
a second transistor having a first conduction terminal coupled to the second output node and a second conduction terminal coupled with the second input node;
the method comprising, when said AC voltage is equal to zero, and when said first thyristor is conductive and said first and second transistors are non-conductive, applying a first positive current to a gate of said third thyristor.

2. The method according to claim 1, further comprising, when said AC voltage is equal to zero, and when said second thyristor is conductive and said first and second transistors are non-conductive, applying a second positive current to a gate of said fourth thyristor.

3. The method according to claim 1, wherein said first and second transistors are NMOS-type transistors.

4. The method according to claim 1, wherein said first, second, third, and fourth thyristors are configured to receive a maximum voltage in the order of 1,200 V across their conduction terminals.

5. The method according to claim 1, wherein said converter further comprises a coil coupling said second output node with an intermediate node between said first and second transistors.

6. The method according to claim 1, wherein said DC voltage is applied between the first and second input nodes, and said AC voltage supplied between said first and second output nodes.

7. A converter of a DC voltage into an AC voltage, comprising:
a first thyristor having an anode coupled to a first input node and a cathode coupled to a first output node;
a second thyristor having an anode coupled to the first output node and a cathode coupled to a second input node;
a third thyristor having an anode coupled with the first output node and a cathode coupled to the first input node;
a fourth thyristor having an anode coupled to the second input node and a cathode coupled to the first output node;
a first transistor having a first conduction terminal coupled to the first input node and a second conduction terminal coupled to a second output node;
a second transistor having a first conduction terminal coupled to the second output node and a second conduction terminal coupled with the second input node; and
a circuit configured, in response to said AC voltage being equal to zero and when said first thyristor is conductive and said first and second transistors are non-conductive, to apply a first positive current to a gate of said third thyristor.

8. The device according to claim 7, wherein said circuit comprises:
a first resistor coupled between a supply node and a first node;
a capacitor coupled between the first node and the cathode of the third thyristor;
a bipolar transistor having a collector coupled to the first node and an emitter coupled to the gate of the third thyristor;
wherein a base of said bipolar transistor is controlled to turn on the bipolar transistor in response to said AC voltage being equal to zero and when said first thyristor is conductive and said first and second transistors are non-conductive.

9. The device according to claim 8, further comprising an optocoupler circuit coupled to the base of the bipolar transistor.

10. The device according to claim 8, further comprising a second resistor coupled between the emitter of the bipolar transistor and the gate of the third thyristor.

11. The device according to claim 7, wherein said first positive current is delivered by a power supply circuit.

12. The device according to claim 7, wherein said circuit is further configured, in response to said AC voltage being equal to zero and when said second thyristor is conductive and said first and second transistors are non-conductive, to apply a second positive current to a gate of said fourth thyristor.

13. The device according to claim 12, wherein said second positive current is delivered by a power supply circuit.

14. The device according to claim 7, wherein said first and second transistors are NMOS-type transistors.

15. The device according to claim 7, wherein said first, second, third, and fourth thyristors are configured to receive a maximum voltage in the order of 1,200 V across their conduction terminals.

16. The device according to claim 7, wherein said converter further comprises a capacitor coupling the first and second input nodes.

17. The device according to claim 7, wherein said converter further comprises a coil coupling said second output node with an intermediate node between said first and second transistors.

18. The device according to claim 7, wherein said DC voltage is applied between the first and second input nodes, and said AC voltage is supplied between said first and second output nodes.

19. A charger comprising a converter according to claim 7.

20. A solar panel comprising a converter according to claim 7.

21. An automotive vehicle comprising a converter according to claim 7.
